(19) United States
(12) Patent Application Publication
(10) Pub. No.: US 2005/0080686 A1
(43) Pub. Date: Apr. 14, 2005

(54) Method and system for internet transactions

(76) Inventors: Gerald Edward Fallon, Lakewood, OH (US); John J. Wright, Garfield Hts., OH (US); Alan Garrison, North Royalton, OH (US)

Correspondence Address: Jay F. Moldovanyi, Esq.;Fay, Sharpe, Fagan, Minnich & McKee, LLP, Seventh Floor, 1100 Superior Avenue, Cleveland, OH, 44114-2518, US

(21) Appl. No.: 10/932,805

(22) Filed: Sep. 2, 2004

Related U.S. Application Data
(60) Provisional application No. 60/501,549, filed on Sep. 9, 2003.

(51) Int. Cl. G06F 17/60

(52) U.S. Cl. 705/26

(57) ABSTRACT

A method of processing Internet-based orders. The method includes providing a portal Web site on the Internet via a Web server, the Web site hosting a plurality of businesses that accept Internet orders via a Web server; receiving a customer's general information, via a customer's communication device; generating an order record in a database; storing the customer's general information in the order record; displaying to the customer via the Web site the plurality of businesses; updating the order record with the customer's chosen business; displaying to the customer via the Web site a list of goods, services, or both that the chosen business provides to the customer; receiving the customer's order information; and processing the customer's order information.

### FIELD OF THE INVENTION

The present invention relates to customer/vendor transactions that occur over the Internet. It finds particular application in conjunction with on-line ordering from restaurants via an Internet portal, and will be described with particular reference thereto. However, it is to be appreciated that the present invention is also amenable to other like applications.

### BACKGROUND OF THE INVENTION

The use of the Internet as a tool for conducting business transactions continues to grow. Consumers are using their computers to conduct all types of transactions, such as the buying and selling of stocks, banking, and even food ordering. For example, consumers may wish to order carryout or delivery from a local restaurant over the Internet. However, consumers generally need to go to the individual restaurant's Web site to place their order. If the consumer does not know which local restaurants allow Internet ordering, then the consumer would need to engage in time consuming research to find such restaurants.

What is needed is a more efficient process for conducting customer/vendor transactions over the Internet, for example, those involving carryout or delivery orders from restaurants.

### BRIEF SUMMARY OF THE INVENTION

According to one embodiment of the present invention, a method of processing Internet-based orders is provided. The method comprises: providing a portal Web site on the Internet via a Web server, the Web site hosting a plurality of businesses that accept Internet orders via a Web server; receiving a customer's general information, via a customer's communication device; generating an order record in a database; storing the customer's general information in the order record; displaying to the customer via the Web site the plurality of businesses; updating the order record with the customer's chosen business; displaying to the customer via the Web site a list of goods, services, or both that the chosen business provides to the customer; receiving the customer's order information; and processing the customer's order information.

According to another embodiment of the present invention, a system for processing Internet-based orders is provided. The system includes a memory having program instructions that provide a portal Web site on the Internet, the Web site hosting a plurality of businesses that accept Internet orders, receive a customer's general information, via the customer's communication device, generate an order record in a database, store the customer's general information in the order record, display to the customer, via the Web site, the plurality of businesses, update the order record with the customer's chosen business, display to the customer via the Web site a list of goods, services, or both that the chosen business provides to the customer, receive the customer's order information, and process the customer's order information. The system also includes a processor for executing the program instructions.

According to yet another embodiment of the present invention, a system for processing Internet-based food orders is provided. The system includes a Web server for providing a portal Web site on the Internet, the Web site hosting a plurality of restaurants that accept Internet orders via a Web server; means for receiving a customer's general information, via a communication device of the customer; means for generating an order record; a database for storing the customer's general information in the order record; means for displaying to the customer via the Web site at least some of the plurality of restaurants; means for updating the order record with the customer's chosen restaurant; means for displaying to the customer via the Web site the chosen restaurant's carryout or delivery menu; means for receiving the customer's order information; and means for processing the customer's order information.

Further aspects of the present invention will be described in the detailed specification provided below.

### BRIEF DESCRIPTION OF THE DRAWINGS

The invention may take physical form in certain parts and arrangements of parts, preferred embodiments of which will be described in detail in this specification and illustrated in the accompanying drawings which form a part hereof and wherein:

FIG. 1 is a representative system in which the present invention may be implemented;

FIG. 2 is a flowchart illustrating the conventional processing associated with an HTTP request from the Web client to the Web server shown in FIG. 1;

FIG. 3 is a simplified block diagram of the menus and menu sections for a restaurant according to a preferred embodiment of the present invention;

FIG. 4 is a simplified block diagram of a restaurant order according to a preferred embodiment of the present invention;

FIG. 5 is a flow chart of an Internet ordering system according to a preferred embodiment of the present invention;

FIG. 6 is block diagram of the Internet ordering system;

FIG. 7 is a screen shot of a Web page showing, by way of example, a list of restaurants offering delivery/carryout services; and

FIG. 8 illustrates a sample order that may be generated using the ordering system shown in FIG. 5.

### DETAILED DESCRIPTION

The World Wide Web is the Internet's multimedia information retrieval system. In the Web environment, client machines effect transactions to Web servers using the Hypertext Transfer Protocol (HTTP), which is a known application protocol providing users access to files (e.g., text, graphics, images, sound, video, etc.) using a standard page description language known as Hypertext Markup Language (HTML). HTML provides basic document formatting and allows the developer to specify “links” to other servers and files. In the Internet paradigm, a network path to a server is identified by a so-called Uniform Resource Locator (URL) having a special syntax for defining a network connection. Use of an HTML-compatible browser (e.g., Netscape Navigator or Microsoft Internet Explorer) at a client machine involves specification of a link via the URL. In response, the client makes a request to the server (sometimes referred to as a “Web site”) identified in the link and, in return, receives in return a document or other object formatted according to HTML.

The present invention is preferably implemented in a client-server computer network. Thus, by way of background, a representative Web client/Web server network is illustrated in FIG. 1. In particular, a client machine 10 is connected to a Web server platform 12 via a communication channel (or network) 14. For illustrative purposes, the network 14 is the Internet, an intranet, an extranet or any other known network connection. The Web server platform 12 is one of a plurality of servers, which are accessible by the client, one of which is illustrated by the client machine 10. The representative client machine 10 includes a browser 16, which is a known software tool used to access the servers of the network. The Web server platform 12 (generally referred to as a “Web” site) supports files in the form of hypertext documents and objects. The network path to a server is identified by a Uniform Resource Locator (URL), as is well-known.

The representative Web server platform 12 comprises a conventional, commercially available processor 18 and memory 19 running an operating system 20 (e.g., Microsoft Windows or Debian GNU/Linux) and a Web server program 22 (e.g., Microsoft IIS (Internet Information Services) or Apache HTTPD Web Server). Generally, the software is written in “plain” PHP (the scripting language) that can run under most Web servers available, whether commercial or open source.

Memory 19 is a data storage device, such as a hard disk, magnetic or optical storage unit, or CD-ROM drive, and stores databases used in processing transactions consistent with the present invention. The processor 18 is any commercially available processor with sufficient memory and processing capability to perform the desired functionality. The Web server platform 12 includes an Application Programming Interface (API) 23 that provides extensions to enable application developers to extend and/or customize the core functionality thereof through software programs commonly referred to as “plug-ins.” The Web server platform 12 also includes a Web-based interface 24 for management and administration. The Web server platform 12 is also linked to a database server 25 for storing customer order information in accordance with the present invention. The Web server platform 12 and the database server 25 involve different software processes, and they typically exist on separate computers, although they may share the same processor.

A representative client machine 10 is a personal computer, notebook computer, personal digital assistant (PDA), wireless telephone, or any other device for communicating on the Internet, that includes an operating system 26, such as Microsoft Windows XP, MAC OS 10, Linux or any other known operating system, and the browser 16, which may be Netscape 7.2, Internet Explorer 6.0 or any other known browser. The browser may have a Java Virtual Machine (JVM) and support for application plug-ins. For example, a JVM would be necessary if the user is logging in to administer a restaurant in the database server 25. The client machine 10 also includes a graphical user interface (GUI) 28 for management and administration. GUI refers to the use of pictures rather than just words to represent the input and output of a program. A program with a GUI runs under some “windowing” system (e.g. Mac OS, Microsoft Windows, Linux). The program displays certain icons, buttons, dialogue boxes, etc. in its windows on the screen and the user controls it mainly by moving a pointer on the screen (typically controlled by a mouse) and selecting certain objects by pressing buttons on the mouse while the pointer is pointing at them.

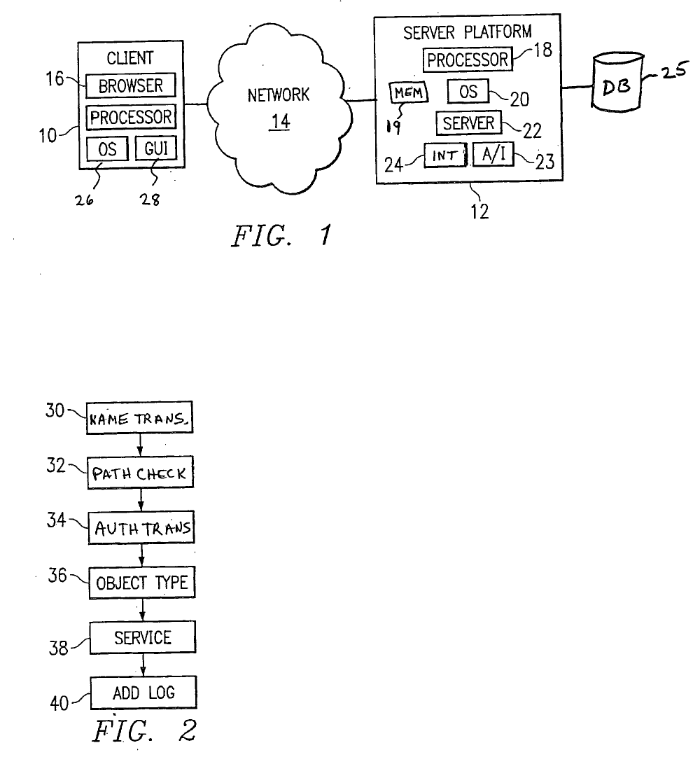

As is well-known, the Web server 12 accepts a client request and returns a response. The operation of the server program 22 is governed by a number of server application functions, each of which is configured to execute in a certain step of a sequence. This sequence, illustrated in FIG. 2, begins with step 30, called name translation, the URL associated with the request may be kept intact or it can be translated into a system-dependent file name, a redirection URL or a mirror site URL. At step 32, called path checks, the server performs various tests on the resulting path to ensure that the given client may retrieve the document. At step 34, authorization translation, during which the server translates any authorization information sent by the client into a user and a group, may take place. If necessary, the authorization translation step may decode a message to get the actual client request. At step 36, sometimes referred to as object types, MIME (Multipurpose Internet Mail Extension) type information (e.g., text/html, image/gif, etc.) for the given document is identified. At step 38, called Service, the Web server routine selects an internal server function to send the result back to the client. This function can run the normal server service routine (to return a file), some other server function (such as a program to return a custom document) or a CGI program. At step 40, called Add Log, information about the transaction is recorded.

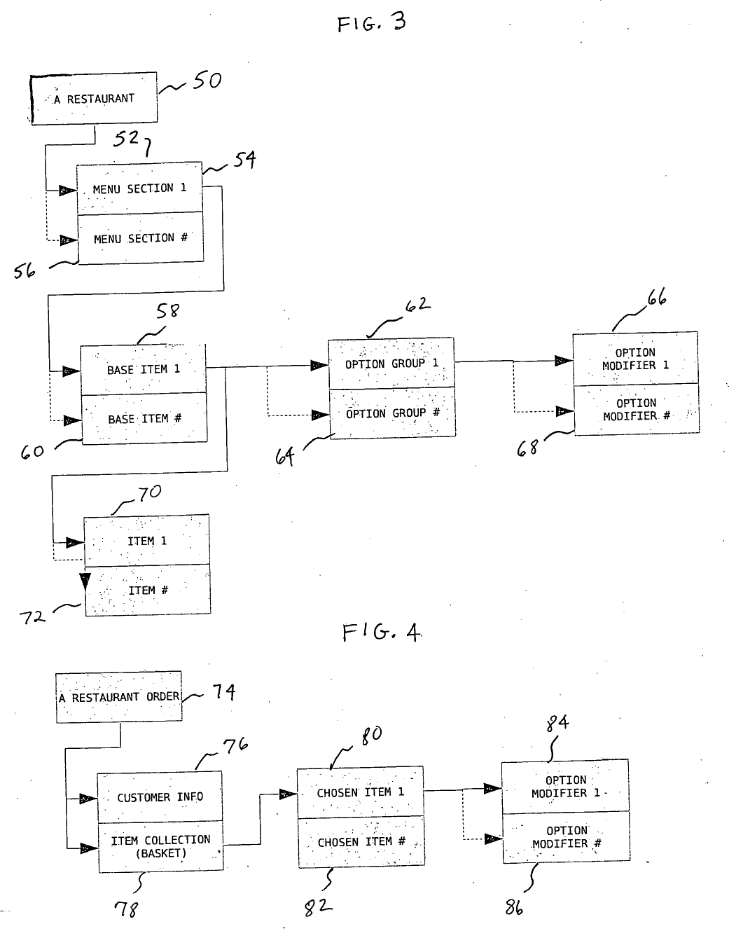

With reference now to FIG. 3, there is shown block diagram representing a restaurant 50 and its menu(s) 52. Each menu 52 is first grouped into menu sections 54, 56 (e.g., pizzas, sandwiches, soups, salads and beverages). The rendering reads each section one at a time and within each section renders the base item records 58, 60. A base item is a grouping of one or more actual food items. Each base item belongs within a restaurant's section.

A base item may be related to any number of option groups 62, 64. An option group consists of any number of option modifiers 66, 68. For example, the option groups 66, 68 may be “Pizza Toppings” or “Burger Condiments.” An option group may be related to any number of base items.

The items 70, 72 are the actual food items that a customer orders. Each of the items 70, 72 has a base price along with other information. Each of the items 70, 72 can only belong to one base item.

The option modifiers 66, 68 represent something that could possibly adjust the price of an item (or not). For example, a single option modifier would be an individual pizza topping, which would belong in the “Pizza Topping” option group. An option modifier may specify a price modifier which could adjust the overall price of a specific menu Item of the customer's order if selected.

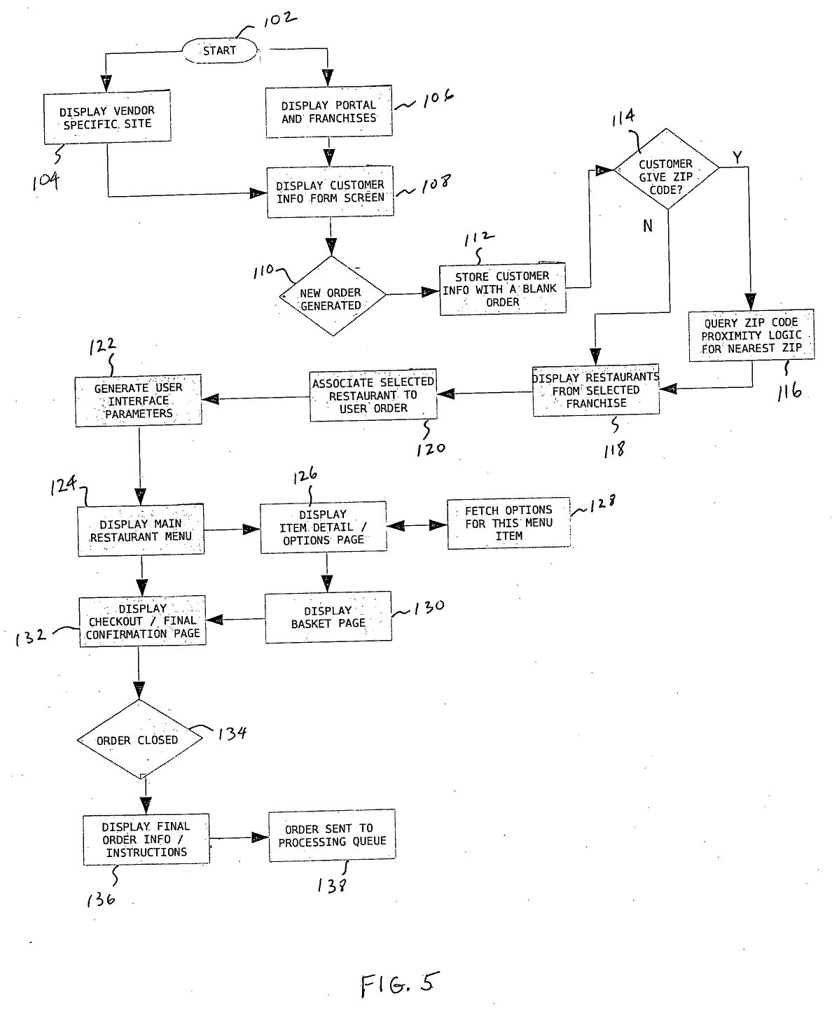

Turning now to FIG. 4, a client's order 74 generally consists of (a) client (or customer) information 76, such as name, zip code, phone number, email address, etc., and (b) an item collection (or basket) 78. Alternatively, the invention may support the establishment of customer accounts. In this way, the client would not have to enter all of the customer information listed above and simply log-in to the Web site with a username and password. The basket 78 will typically contain one or more items 80, 82 that the client has selected. Each item in an order 74 may have any number of option modifiers 84, 86 associated with the item, depending on what the customer selects. The order item field also has a quantity if the client would like more than one of those Items. An order may contain multiple instances of the same item—this typically means that there would be different option modifiers selected with each order item instance. The total dollar cost of an order item is the base cost of the item plus the sum of all the option modifier modifying prices. The total dollar cost of the order is the sum of all of the items plus the respective option modifiers' prices.

Each item in an order item field may have any number of option modifiers selected. For example, if the customer is ordering a pizza with toppings, the pizza would be the Item and there would be an instance of an order item option modifier for each topping, each with its own description and price modifier. Each chosen item in a customer's order may have zero to many option modifiers that may or may not affect that item's price.

Referring now to FIG. 5, in step 102, the ordering process may start at a particular vendor's Web site. If a customer starts at a vendor Web site, the vendor Web site would provide a customized link to a portal, such as the TakeOutUSA engine (www.takeout-usa.com), that immediately puts the customer in that vendor's menu (or possibly a store locator). The order is “born” once the customer selects a particular restaurant. In this way, there is no need for the customer to choose a franchise. Alternatively, the process can start by going to a generic portal Web site, such as the TakeOutUSA engine, where the customer may choose from any number of franchise restaurants in the system.

In step 104, a franchise Web site is given a specially encoded URL to connect to the portal, such as the TakeOutUSA engine. This can be done via a HTML frame so as to hide the fact that the customer is going off of the franchise website. The portal will then list all the active franchises in the system (step 106). The system will ask the customer for various types of information about the customer, such as name, zip code, phone number and email address (step 108). This page requires, at a minimum, that the name be entered.

A new blank order with a unique MD5-hash identifier is then created (step 110). To prevent a random Web surfer from interacting with other people's orders by manipulating the “order_id” data in the URL, the md5-hash identifier is created. An MD5 hash is a 32-character alpha-numeric string, and a new one is assigned to each individual order. The hash is used in the URL and put in hyperlinks, but beyond that the user does not directly see the order_id. Given that each order has a unique, random hash, the random Web surfer guessing another person's order based on a different hash is statistically improbable. MD5 is only one of many hashing algorithms known to those skilled in the art, and the Web server 12 could easily be updated to use other ones. Utilizing other hashes, perhaps along with md5, would further decrease the chances of someone interfering with other people's orders. The user information received from the customer in step 108 is stored in an order record in the database server 25 (step 112).

Next, a determination is made by the Web server 12 as to whether the customer gave a zip code (step 114). If so, then the zip code is run through a zip code proximity logic via the Web server 12 to order the restaurant listing by nearest locations (step 116). After the customer shares their contact information, the Web server 12 will create a list of nearby restaurants in the customer's area for the selected franchise (step 118). The customer can now decide which restaurant to order their food from. The customer may also be provided with a map of the nearby location of the restaurant. The Internet mapping service would provide convenient step-by-step directions to find the restaurant from any address via a third party service, such as Yahoo! Maps or MapQuest. The order is then updated, as the customer has now selected the desired restaurant (step 120).

Before the Web server 12 shows the menu, it will pull the graphics and style sheets for the chain, franchise, and restaurant, preferably in that order, from the database server 25, where successive settings will override the prior settings (step 122). The carryout/delivery menu for the restaurant is displayed on the client machine 10, and the menu is grouped by section, base item, and item, generally in that order (step 124). The same carryout/delivery menu for all restaurants for a particular franchise may be presented, or there may be a customized carryout/delivery menu for each restaurant. The menu is built to the restaurant's specifications: the restaurant can use its unique sectional names (Starters, Appetizers, etc.) and can place as many or as few sections on the menu as desired. When they find something they like, they can simply click on a link on the Web site to add the item to their order—and, at that time, they can select variations of the item. Regarding the section/base item layout, the vendor also has the option to choose how each section is rendered. That is, there are different layout options that can be assigned to each section which set up the links and descriptions differently.

Next, the item detail/options page is displayed on the client machine 10 (step 126). The customer can scroll down the menu (or select a section from the top of the menu to “jump” to that section) and view the food offerings. When the customer clicks on an item, the customer is taken to the item page. All the option groups and option modifiers for the selected item are fetched and rendered by the Web server 12 (step 128).

If the customer adds the item to the individual order basket, the customer is taken to the basket page, which typically shows the contents of the current order (step 130). The order confirmation page allows the customer to update the general information asked for earlier in the process (step 132). From here, the customer can also change the quantities or remove items from the order. The customer may also check out at this point. The pickup time is based on the restaurant's hours of operations and the restaurant can select the soonest possible pickup time from the time the customer placed their order.

By way of example, the restaurant may select thirty minutes for food preparation time. Thus, the soonest pickup time would be thirty minutes from the time the order was placed. The customer would be permitted to select other times in thirty minute increments (or any other suitable increments). The restaurant may also take payment over the Internet from a variety of customer credit card options. This may save the customer (and employees) time at food pickup, since they won't have to go to the register. Alternately, the customer can select payment at pickup or use an account they may have with the restaurant. The restaurant is provided the contact information with each order, so it can easily verify the order with the customer, if necessary.

At the point of checkout, the Web server 12 will update the order record in the database server 25, indicating that the order is now in a “Closed” state (step 134). The order cannot be updated by the user at this point. The Web server 12 will print the final order, the location of the restaurant, and an engine-generated order number (step 136). The order is now marked to be processed by the queue (step 138).

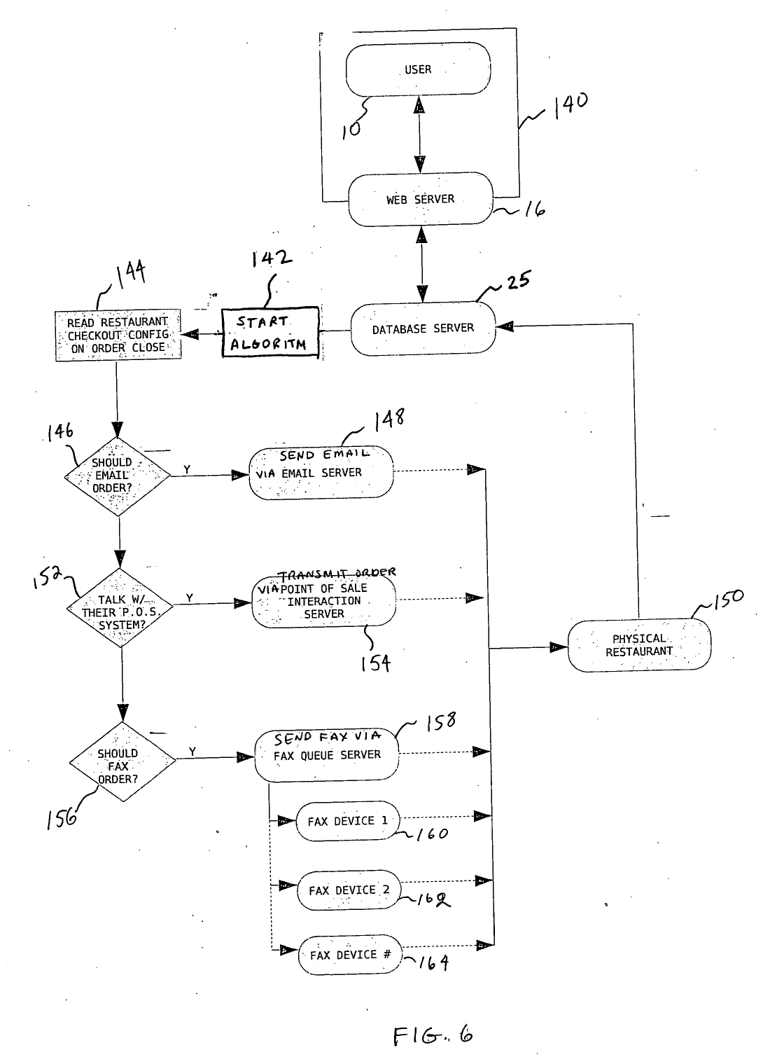

FIG. 6 is a schematic diagram further illustrating the Internet-based ordering process. Block 140 represents the customer, who is using the client machine 10 to connect to the Web server 16. The Web server 16 is in communication with the database server 25. In step 142, the queue processing algorithm is started. Different restaurants may have post-order options, so the status flags for that restaurant are fetched (step 144). Next, the handling of the order based upon the restaurant's post-order options is determined.

Thus, the Web server 12 determines whether the order should be emailed to a specified email address (step 146). If so, then the Web server 12 creates a PDF version of the order, as known in the art, and attaches the PDF version to an email, which contains a plain text order listing. The email is then sent via an email server to the restaurant 150 (step 148).

Next, the Web server 12 determines whether the order should be transmitted to the restaurant's Point-of-Sale system (step 152). If so, then the necessary interaction software is run on the Web server 12 and the order is transmitted via a Point-of-Sale interaction server to the restaurant 150 (step 154).

Then, the Web server 12 determines whether the order should be faxed to the restaurant 150 (step 156). If so, the Web server 12 creates a fax queue entry with the fax contents (a PDF file converted to fax format). In step 158, the fax queue will pick up the next queued fax and send it to the next available fax modem 160, 162, or 164.

Special screens set up on the database server 25 will let restaurant owners log in through a Web site and see their restaurant's traffic by means of customized reports.

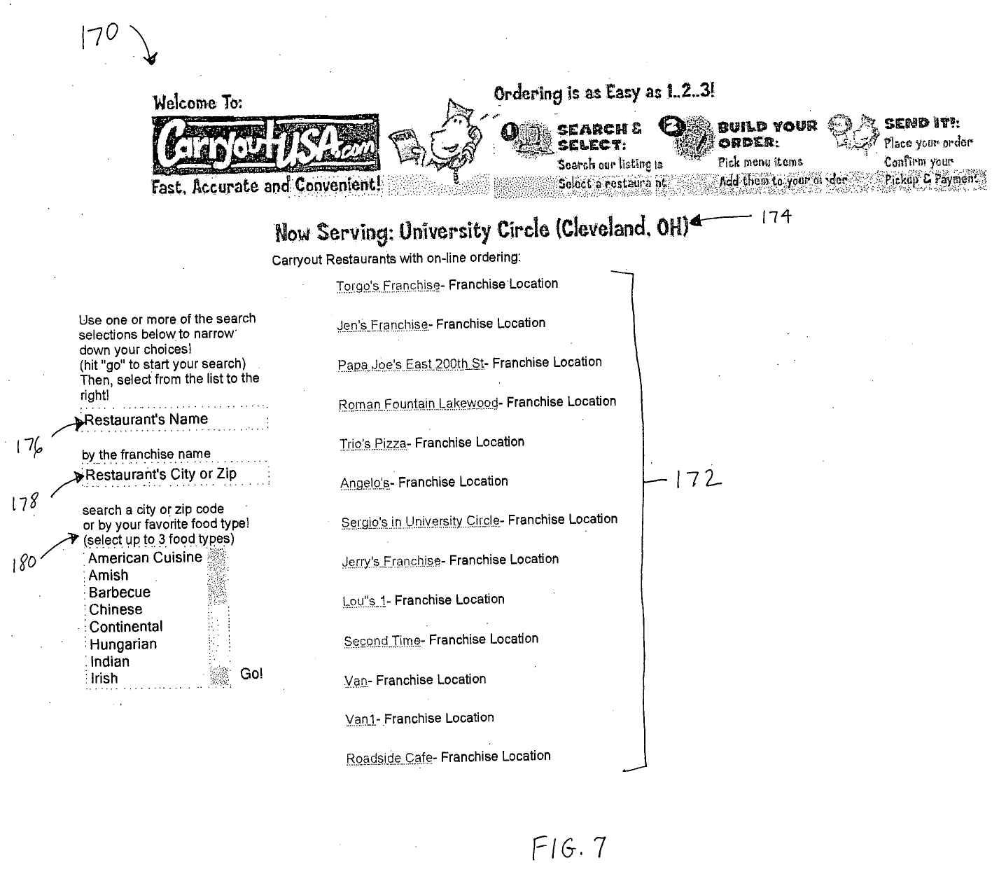

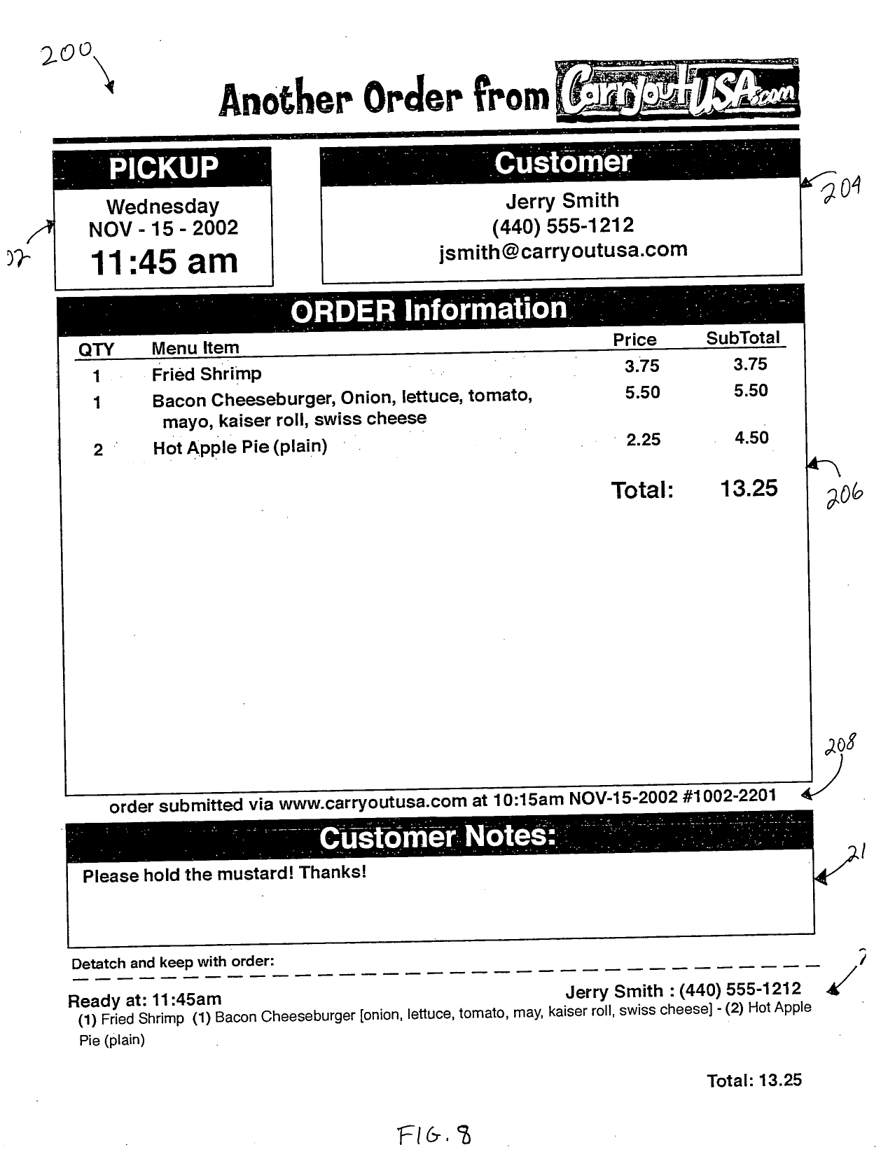

FIG. 7 is a screen shot of a Web page 170 showing, by way of example, the browser 16 used on the client machine 10 of FIG. 1. In the described embodiment, a HTML Web page for viewing on a browser application. The Web page 170 provides a list of restaurants 172 that provide delivery/carryout services in a given area 174. The customer may use one or more of the search selections to narrow down the choices. The selections include franchise name 176, city or zip code 178, or by type of food 180 (e.g., American Cuisine, Chinese, Indian, etc.).

FIG. 8 illustrates an example of an order 200 generated by the method of the present invention. In the described embodiment, the order 200 is generated and sent as by fax, email or direct entry into the restaurant's Point-of-Sales system, as described above. The order 200 may display, among other things, the requested pickup time 202, the customer contact information 204, the order 206, pertinent order submission information 208, customer notes 210, if any, and/or an optional detachable order slip 212. The order slip 212 can be routed with the food preparation and included with the customer's order.

In an alternative embodiment, the Internet-ordering method described above may be used in conjunction with student debit cards, such as those used by colleges and universities for their student meal plans. In particular, a Web site, which may be a school's Web site, that is accessible to student cardholders would be provided for placing orders for food to be picked up or delivered. The Web site could support any number of restaurants in the area surrounding the campus. The ordering method would be substantially the same as described above. However, payment for the order would differ slightly. That is, the Web site would accept the student's debit card number and password as payment for the order. The order could go straight through to the restaurant, or, alternatively, the order could be sent via e-mail (or fax) to an appropriate college or university representative for approval and placement into a queue.

The invention has been described with reference to the preferred embodiments. Obviously, modifications and alterations will occur to others upon reading and understanding the preceding detailed description. It is intended that the invention be construed as including all such modifications and alterations insofar as they come within the scope of the appended claims or the equivalents thereof.

1. A method of processing Internet-based orders comprising:
providing a portal Web site on the Internet via a Web server, the Web site hosting a plurality of businesses that accept Internet orders via a Web server;
receiving a customer's general information, via a customer's communication device;
generating an order record in a database;
storing the customer's general information in the order record;
displaying to the customer via the Web site the plurality of businesses;
updating the order record with the customer's chosen business;
displaying to the customer via the Web site a list of goods, services, or both that the chosen business provides to the customer;
receiving the customer's order information; and
processing the customer's order information.

2. The method defined in claim 1, further comprising:
updating the order record with the customer's order information;
providing the customer's order to the chosen business; and
marking the order to be processed via a queue processing system.

3. The method defined in claim 1, wherein the customer's general information includes at least one of name, zip code, phone number, and email address.

4. The method defined in claim 1, wherein the customer's general information includes the customer's zip code.

5. The method defined in claim 4, further comprising the step of using the customer's zip code to locate the nearest businesses to the customer within a given parameter.

6. The method defined in claim 1, wherein the businesses are restaurants.

7. The method defined in claim 6, wherein the services that the businesses provide to the customer include food delivery.

8. The method defined in claim 7, wherein the customer's order information includes at least one food item and at least one option modifier.

9. The method defined in claim 1, wherein the communication device comprises at least one of a personal computer, a personal digital assistant, a notebook computer, and a wireless telephone.

10. A system for processing Internet-based orders comprising:
a memory having program instructions that
provide a portal Web site on the Internet, the Web site hosting a plurality of businesses that accept Internet orders,
receive a customer's general information, via the customer's communication device,
generate an order record in a database,
store the customer's general information in the order record,
display to the customer, via the Web site, the plurality of businesses,
update the order record with the customer's chosen business,
display to the customer via the Web site a list of goods, services, or both that the chosen business provides to the customer,
receive the customer's order information, and
process the customer's order information; and
a processor for executing the program instructions.

11. The system defined in claim 10, wherein the memory further includes program instructions that
update the order record with the customer's order information;
provide the customer's order to the chosen business; and
mark the order to be processed via a queue processing system.

12. The system defined in claim 10, wherein the customer's general information includes at least one of name, zip code, phone number, and email address.

13. The system defined in claim 10, wherein the customer's general information includes the customer's zip code.

14. The system defined in claim 13, wherein the memory further includes program instructions that use the customer's zip code to locate the nearest businesses to the customer within a given parameter.

15. The system defined in claim 10, wherein the businesses are restaurants.

16. The system defined in claim 15, wherein the services that the business provides to the customer include food delivery.

17. The system defined in claim 16, wherein the customer's order information includes at least one food item and at least one option modifier.

18. The system defined in claim 10, wherein the communication device comprises at least one of a personal computer, a personal digital assistant, a notebook computer, and a wireless telephone.

19. A system for processing Internet-based food orders comprising:
a Web server for providing a portal Web site on the Internet, the Web site hosting a plurality of restaurants that accept Internet orders via a Web server;
means for receiving a customer's general information, via a communication device of the customer;
means for generating an order record;
a database for storing the customer's general information in the order record;
means for displaying to the customer via the Web site at least some of the plurality of restaurants;
means for updating the order record with the customer's chosen restaurant;
means for displaying to the customer via the Web site the chosen restaurant's carryout or delivery menu;
means for receiving the customer's order information; and
means for processing the customer's order information.

20. The system defined in claim 19, further comprising:
means for updating the order record with the customer's order information;
means for providing the customer's order to the chosen restaurant; and
means for marking the order to be processed via a queue processing system.

21. The system defined in claim 19, further comprising:
means for establishing a customer account on the Web server, wherein the customer account is prepaid and has a preselected dollar amount; and
means for deducting from the customer account the amount specified in the order information.

22. The system defined in claim 19, further comprising means for charging a customer's credit card for the customer's order.

23. The system defined in claim 19, further comprising means for selecting a subset of the plurality of restaurants, dependent on the general information received from the customer.
